(19) United States
(12) Patent Application Publication
(10) Pub. No.: US 2019/0077685 A1
(43) Pub. Date: Mar. 14, 2019

(54) Application to reinforce the immunity of Daphnia and to use them as bio filters to improve water quality of aquatic ecosystems

(71) Applicant: Arevik Minasyan, Yerevan (AM)

(72) Inventor: Arevik Minasyan, Yerevan (AM)

(21) Appl. No.: 15/702,859

(22) Filed: Sep. 13, 2017

(51) Int. Cl. C02F 3/32; A01K 63/04; A01K 61/13; A01K 61/59; A23K 50/80; A23K 10/10; A23K 20/10

(52) U.S. Cl. CPC C02F 3/327; A01K 63/045; A01K 61/13; C02F 2303/04; A23K 50/80; A23K 10/10; A23K 20/10; A01K 61/59

(57) ABSTRACT

This invention is about how to create a principle water natural-filters, such as Daphnia with reinforced resistance to pathogen and toxic microorganisms, by using Haematococcus pluvialis, as its dietary. Astaxanthin is a key carotenoid of Haematococcus pluvialis sustaining the tolerance of Daphnia to gain immunity to toxic algae and pathogen bacteria. Due to obtained resistance, Daphnia can survive even in waters with high content of pathogen bacteria and algal toxins and filter higher volume of water. This cannot be achieved with any other technologies by now without need in chemicals (bactericides and algaecides). In this conditions Daphnia, especially new-born offsprings, get intoxicated and die, which disrupts natural self-cleaning capacity of aquatic ecosystem. As an indirect effect pre-treated and resistant Daphnia reduce odor effect of the aquatic ecosystems due to elimination of the odor compounds producing bacteria and algae.

The current invention describes using anti-oxidant properties of carotenoids/astaxanthin to strengthen tolerance of Daphnia. Daphnia (parthenogenetic daughters, neonates, adults of both sexes), being fed with astaxanthin containing Haematococcus pluvialis, gain enhanced tolerance and filter higher volume of water during their life period in aquatic ecosystems and reduce density of bacteria and algae. Addition of pre-treated Daphnia with reinforced resistance, furthermore, control growth of viruses, pathogens and toxin-producing algae in aquatic ecosystems, and appliance of antibiotics or chemicals (bacteriocides and algacides) has no further requirement (or can be significantly cut off). Haematococcus pluvialis, a typical planktonic inhabitant of aquatic ecosystems that synthesizes series of antioxidant carotenoids, including such as β-carotene, lutein, canthaxanthin, zeaxanthin. It also produces red pigment so-called astaxanthin (red ketocarotenoid)—(3,30-dihydroxy-b-b-carotene-4,40-dione) with the cis- and transisoforms configuration. Astaxanthin produced by Haematococcus pluvialis contains three groups with up to 4% of free astaxanthin, 94% of astaxanthin monoesters, and 2% of astaxanthin diesters (Holtin et al., 2009).

In presence, any type of aquatic ecosystems receives an extra amount of pollutions reaching with water withdrawals, agriculture, industry, housekeeping, mining activities, etc. Nutrients high run-off stimulates a rapid growth of algae (so-called algal bloom). Grown algae result in the reduction of water quality due to oxygen depletion because of bacterial decomposition of algal extra biomass by bacteria, and often are associated with bad odors in water-bodies. In many cases certain algal strains, such as of cyanobacteria, diatoms and dinoflagellates, produce well-described toxins and release them into water. Although, some concentrations of algal toxins are released into water, the major portion of them remains inside the algal cells and appears in water after algal cells decay. Algal toxins and pathogens in their turn stress physically or even can remain lethal outcome nearly for all organisms living in the aquatic ecosystem or getting in touch with contaminated water. Eutrophication is a widely reported issue of aquatic ecosystems to cause oxygen limitation or complete depletion in water. In that situation expensive treatment, such as aeration, requires. In case of water toxic bloom, toxins, that are not degrading by aeration, remain in water column or accumulate in inshore waters and on the bottom of water-body and become a reason of humans intoxication, mass mortality of fish and shrimp, etc.

Daphnia, also called water filters, are typical filter-type feeders, ingesting various type of microorganisms, including bacteria, algae, protists, etc., may live in various aquatic environments, ranging from acidic swamps to freshwater and saline lakes, natural and man-made ponds, streams and rivers. There are sexual and asexual reproductive cycles of Daphnia. During asexual parthenogenesis, one generation of sexually reproduced neonates is interspersed with many generations of asexual reproduced off-springs under favorable environmental conditions. Asexual phase reproduces high number of offsprings in short time-period, as females mature in 3 to 11 days (Ebert, 2005).

Literature contains a few scientific papers about the data obtained for experiments to feed Daphnia with Haematococcus pluvialis. Aldantara-Azura et al., 2014 demonstrated up to 50% increase in Daphnia size after using Haematococcus pluvialis, compared to data obtained from the experiments of using Sphaerocystis sp. or Chlorella vulgaris as a diet. Snoeijs-Leijonmalm et al., 2016 found Daphnia to consume Haematococcus pluvialis from surrounding waters in the Baltic Sea.

Primarily, the following species of Daphnia have been tested: D. galeata, D. hyaline, D. magna, D. mendotae, D. pulex and D. pulicaria. Besides, 2 clones of genetically modified Daphnia: D.magna and D.pulex have been studied. Obtained results demonstrate that including astaxanthin containing Haematococcus pluvialis as a dietary reveal similar impacts to all Daphnia tested species, including genetically modified clones, and these changes are achieved due to anti-oxidant and immunity stimulating properties of astaxanthin. Every next generation of Daphnia demonstrate stronger driven resistance, higher tolerance to algal toxins and pathogens, increase velocity, and lower mortality. Pre-treated Daphnia will be added to waters of aquatic ecosystems, including natural and man-made freshwater lakes, also man-made ponds (indoor and outdoor) used for aquaculture purposes (to grow fish and shrimp) to improve water quality by filtering water from pathogens, such as viruses, bacteria, algae, including cyanobacterial strains producing generally called cyanotoxins, diatoms, including domoic acid synthesizing Pseudo-nitzschia spp., dinoflagellates, synthesizing generally called dinotoxins, fungi, protists, parasites, etc. For aquatic ecosystems with saline waters Daphnia, fed with astaxanthin producing Dunaliella salina, will be applied to obtain the similar results of reinforced resistance to pathogens and algal toxins.

Since higher abundance of bacteria and algae requires greater number of Daphnia to ensure proper treatment, therefore, for aquatic ecosystems with higher total density of algae and bacteria, greater number of pre-treated Daphnia will be applied. As Daphnia consumes algae and bacteria, including virulent and faecal bacteria, this invention will control human health risk, if contaminated water being used directly; reduce the health risk for fish and shrimp and make grown in aquaculture fish and shrimp ecologically more relevant for human consumption.

This invention is intended to being applied in all type of aquatic ecosystems, including natural freshwater or saline lakes, as well as man-made indoor and outdoor ponds, basins and aquariums with fresh or saline waters, to solve the water quality related issues.

### BRIEF DESCRIPTION OF THE FIGURES

FIG. 1 is a graphical illustration of data received from the experiments of changes in Daphnia mortality rate (mean values in %) exposed to aquatic ecosystems abundant in virulent bacteria, toxic cyanobacteria, diatoms, dinoflagellates, after being fed with astaxanth in containing Haematococcus pluvialis.

FIG. 2 is graphical illustration of results of changes in Daphnia mass and size (mean values in %) after being fed with astaxanthin containing Haematococcus pluvialis.

FIG. 3 is graphical illustration of values of total density of bacteria and algae (mean values in %) after addition to aquatic ecosystem of Daphnia fed with astaxanthin containing Haematococcus pluvialis.

FIG. 4 is graphical illustration of ratio of chlorophyll versus phycocianin (mean values in %) after addition to aquatic ecosystem of Daphnia fed with astaxanthin containing Haematococcus pluvialis.

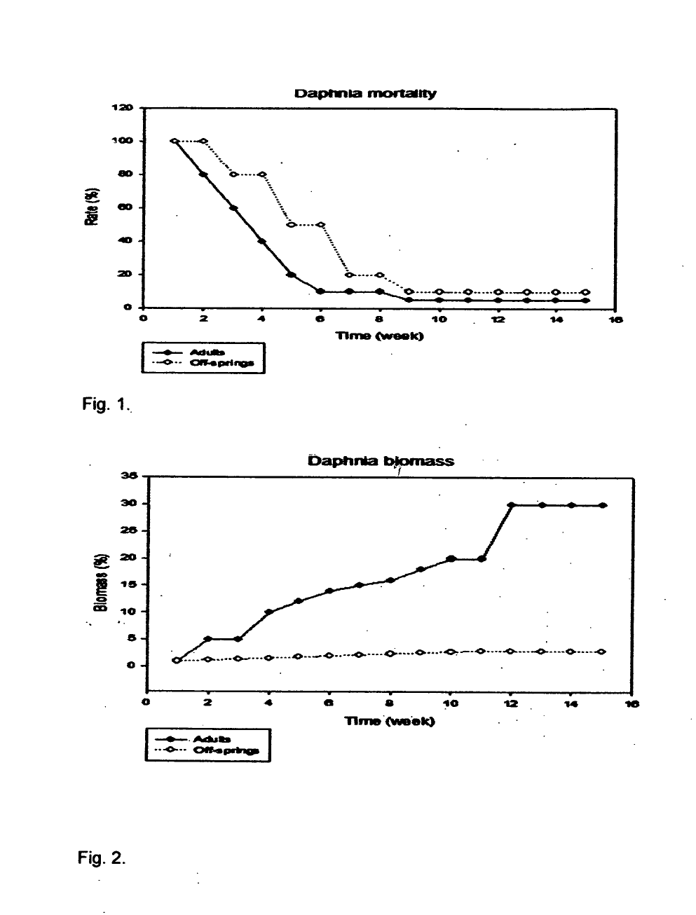

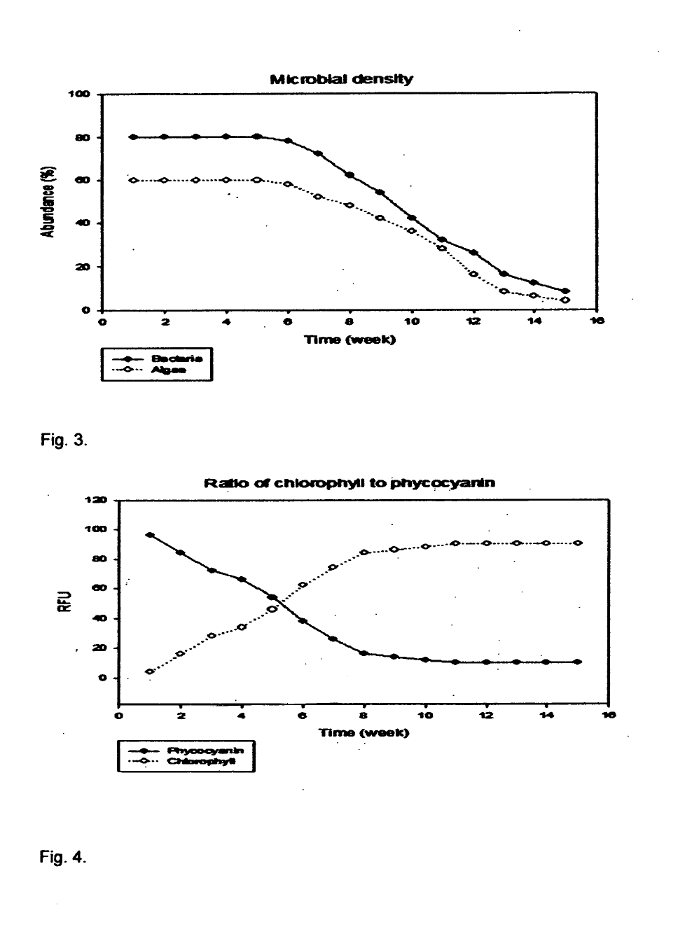

### BACKGROUND OF THE INVENTION

The biogeochemical cycles in aquatic ecosystems are the important drivers of environmental processes in global scale, as they regulate the levels of flow of energy and elements essential for life between different pools. All biogeochemical cycles are interlinked with each other; therefore, cycles may significantly affect environmental conditions at global scales. Alterations in biogeochemical cycles, such as human induced rapid increase of the concentration of certain element/s may change the proportion of those elements in particular pools, by making them too scarce or too abundant. Excess element in a particular pool may involve levels that are poisonous for life or stimulate critical changes in the environmental processes. Nowadays, aquatic ecosystems face a broad range of threats. Together with natural aquatic ecosystems, man-made lakes and ponds, are receiving extra amount of pollutions reaching with water withdrawals, agriculture, industry, housing development, mining activities, etc.

Although aquaculture and fishponds provide many benefits, but still there are several negative concerns linked to them, but correct foresight into these reverse feedbacks can be avoided. The impact fish farming and aquaculture present to the areas is mainly linked to the requirement to manage and ensure a sustainable operation.

Water pollution is a primary concern aquaculture and fishponds have on the surrounding environment. A successful fish farm, for example, requires fish food to sustain its stock. As with any other agricultural practices, the consumption of food by the stock results in waste products. Because the population of a species in a fish farm is significantly denser than what would occur naturally, the generated waste products are more concentrated as well. For a fish farm, if it were left unchecked, the living conditions for the stock would soon become too toxic for survival. The waste material and products for cages or nets at open-air aquacultures are able to cause more dramatic impact and contaminate the surrounding waters.

Many pronounced evidences linked eutrophication to depress immunity of zoo-population of aquatic ecosystem, including Daphnia. Algal high density reduces the protecting capacity of Daphnia to toxins, including cyanotoxins, domoic acid, dinotoxins, as well as pathogens (various viruses, bacterial pathogens, fungal infections, etc.).

Daphnia is a genus of small planktonic organisms from order Cladocera of phylum Crustacean. Daphnia is a group of organisms living in various aquatic environments ranging from acidic swamps to freshwater and saline lakes, natural and man-made ponds, streams and rivers. Daphnia are typical filter-type feeders, ingesting mainly bacteria, algae, including cyanobacteria green algae, diatoms, various types of organic detritus, protists, etc. Daphnia reproductive cycles include parthenogenesis when one generation of sexual reproduction is interspersed with many generations of asexual reproduction. When environmental conditions are favorable Cladocerans such as Daphnia achieve a high reproductive rate asexually by producing eggs that hatch into female offspring that, in turn, asexually produce eggs that also hatch into female offspring, and so on under favorable environmental conditions. Daphnia populations can achieve high growth rates during the asexual phase in short time-period as females mature in 3 to 11 days.

When environmental conditions become unsuitable, Cladocerans such as Daphnia reproduce offsprings sexually. Environmental stressful conditions such as population high density, food scarcity, low or high temperatures, short photoperiod, or chemical cues synthesized by predators, stimulate sexual females mate with males for sexual reproduction persistent in a dormant state. Sexual reproduction creates fertilized zygotes that can further develop into embryos to enter diapause. The transformation into ephippia helps Daphnia population to survive and remain viable for years in sediments before hatching in response to environmental changes.

Due to their filtering feeding type, Daphnia play very significant ecological role in maintaining water quality in aquatic ecosystems, and therefore, based on the high sensitivity to their chemical environment, Daphnia are most commonly extra-added to many aquatic ecosystems to preserve water quality necessary to support healthy riparian, aquatic, and wetland ecosystems to remain in the range required by the biological, physical, and chemical integrity of the system and benefits survival, growth, reproduction, and migration of individuals composing aquatic and riparian communities.

The current invention provides Phylum Crustacea, order Cladocera, Daphnia with enhanced resistance stimulated by Haematococcus pluvialis to filter water of lakes and aquacultures, including man-mad artificial ponds, indoor and outdoor basins with both freshwaters and saline waters, streams and rivers (hereinafter to be named aquatic ecosystems) used to grow various species of fish and shrimp to control a toxic substance in an aforementioned aquatic ecosystems, to reduce cyanobacterial community including nontoxic and toxin-producing strains of all genera in Phylum Cyanobacteria, diatoms, including domoic acid synthesizing Pseudo-nitzschia, dinoflagellates synthesizing generally called dinotoxins, as well as the odour compounds producers.

Haematococcus pluvialis, a typical planktonic inhabitant of aquatic ecosystems, is well known due to its ability to synthesize series of antioxidant carotedoids including such as β-carotene, lutein, canthaxanthin and zeaxanthin. It also produces red pigment so-called astaxanthin (red ketocarotenoid)—(3,30-dihydroxy-b-b-carotene-4,40 dione) with the cis- and trans-isoforms configuration.

Astaxanthin produced by Haematococcus pluvialis contains three groups with up to 4% of free astaxanthin, 94% of singly esterified (astaxanthin monoesters), and 2% of double esterified (astaxanthin diesters). Astaxanthin gained increased interest due to its applications in aquacultural, food, pharmaceutical, and nutraceutical industries, as well as a pigmentation inducer, and as an immune response enhancer and in anti-cancer treatment. Astaxanthin synthesis plays a crucial role in response of Haematococcus pluvialis to various stress conditions (e.g. high light, salinity, nutrient stress, and high carbon/nitrogen ratio). Haematococcus pluvialis life cycles start with:—vegetative stage, when the cell is green and motile with two flagella;—an intermediate motile redding stage, when cell still keeps flagella/s and starts accumulating astaxanthin;—green palmella, when the vegetative cell is in the resting stage and loses the flagella; and the red cyst when the cell covers with thick cell-wall and accumulates maximal astaxanthin.

Daphnia samples being fed with Haematococcus pluvialis gain enhanced resistance and able to filter higher amount of water in aquatic ecosystems and reduce density of any genera of algae, including toxic and non-toxic cyanobacteria, green algae, toxic and non-toxic diatoms, and toxic and non-toxic dinoflagellates, any specie and strain of bacteria including virulent strains, and protists. Due to obtained resistance, Daphnia survive even in waters with high content of pathogen bacteria and algal toxins and filter higher volume of water. As an indirect effect pre-treated and resistant Daphnia reduce odor effect of the aquatic ecosystems due to elimination of the odor compounds producing bacteria and algae.

### SUMMARY

In general, the current invention describes using anti-oxidant properties of carotenoids/astaxanthin to strengthen immune system of the Daphnia and enable protecting mechanism to neutralize the pathogens and parasites before they can harm the host, reproduce or being transmitted. Daphnia with stimulated resistance gain tolerance to pathogens and algal toxins and filter higher volume of water and remove higher amount of bacteria and algae, including virulent bacteria, toxic cyanobacteria, toxic diatoms, toxic dinoflagellates, etc. Mortality rate of pre-treated Daphnia decreases even in waters with high content of toxic algae and pathogen bacteria. Therefore, using antibiotics to protect fish and shrimps from water-born diseases requires no further application (or can be significantly cut off). It demonstrates the Daphnia individuals to increase their:—size and mass;—reproductive activities; mobile velocity and susceptibility to various toxins and pathogens.

### REFERENCES CITED

Alćantara-Azura A. K., Contreras-Rodrigues A. I., Reyes-Arroyo N. E., Castro-Mejia J., Castaneda-Trinidad H., Castro Mejia G y Ocampo-Cervantes J. A. 2014. Density population comparison of Daphnia pulex Müller, 1785 cultured in laboratory conditions, fed with three green unicellular microalgae (Sphaerocystis sp., Chlorella vulgaris and Haematococcus pluvialis). Revista Digital del Departamento 15, pp. 17-23. Ebert D. 2005. Ecology, Epidemiology, and Evolution of Parasitism in Daphnia [Internet]. Bethesda (Md.): National Center for Biotechnology Information (US). Grewe C, Mcnge S, Griehl C. 2007. Enantloselective separation of all-E-astaxanthin and its determination in microbial sources. J. Chromatogr A, 1166(1-2), pp. 97-100. Holtin K, Kuehnle M, Rehbein J, Schuler P, Nicholson G, Albert K. 2009. Determination of astaxanthin and astaxanthin esters in the microalgae Haematococcus pluvialis by LC-(APCI)MS and characterization of predominant carotenoid isomers by NMR spectroscopy. Anal Bioanal Chem. 395(6), pp. 1613-1622. Snoeijs-Leijonmalm P., Schubert H., Radziejewska T. 2016. Biological oceanography of the Baltic Sea. Springer, pp. 62-72.

1. Daphnia, fed with astaxanthin containing Haematococcus pluvialis, increase their lifespan and develop individuals with bigger mass and size resulting in enhanced three-dimensional swimming behavior.

2. Due to reinforced resistance, pre-treated Daphnia, gain transferable to offsprings tolerance and resistance for pathogens and algal toxins and filter higher volume of water and remove higher amount of bacteria and algae, including virulent bacteria, toxic cyanobacteria, toxic diatoms, toxic dinoflagellates, etc.

3. Mortality rate of pre-treated Daphnia decreases even in waters with high content of toxic algae and pathogen bacteria, which means that using antibiotics to protect fish and shrimps from water-born diseases requires no further application (or can be significantly cut off).
